(19) United States
(12) Patent Application Publication
(10) Pub. No.: US 2016/0355272 A1
(43) Pub. Date: Dec. 8, 2016

(54) AIRCRAFT PROPULSION SYSTEM

(71) Applicant: ROLLS-ROYCE plc, London (GB)

(72) Inventor: Matthew MOXON, Derby (GB)

(73) Assignee: ROLLS-ROYCE plc, London (GB)

(21) Appl. No.: 15/133,728

(22) Filed: Apr. 20, 2016

(30) Foreign Application Priority Data
May 13, 2015 (GB) 1508139.1

(51) Int. Cl. B64D 27/12; B64D 41/00; B64C 21/00; B64D 35/04; B64C 11/46; B64D 27/24

(52) U.S. Cl. CPC B64D 27/12; B64C 11/46; B64D 27/24; B64C 21/00; B64D 35/04; B64D 41/00; B64D 2221/00

(57) ABSTRACT

An aircraft propulsion system includes at least first and second propulsor arrangements. Each propulsor arrangement includes an internal combustion engine configured to mechanically drive a plurality of propulsors. At least one of the propulsors of each propulsor arrangement is driveable via a shaft and at least one reduction gearbox. Each internal combustion engine is coupled to a motor generator arrangement configured to drive at least one of the mechanically driven propulsors when in a motor mode, and to generate electrical power when in a generating mode. The system further includes an electrical interconnector configured to transfer electrical power between the first and second propulsor arrangements.

The present disclosure concerns an aircraft propulsion system.

Powered aircraft such as civilian airliners are typically propelled by propulsors in the form of either open rotor propellers or ducted fans, which are typically mechanically driven by either gas turbine engines or reciprocating piston engines. Where a ducted fan is driven by a gas turbine engine, such an arrangement is known as a “turbofan” or “bypass jet”, whereas where an open propeller is driven by a gas turbine engine, such an arrangement is known as a “turboprop”, “open rotor gas turbine” or “propfan”.

In general, there is a trend towards fewer, larger engines in civilian airliners. A typical arrangement in which one relatively large engine is provided on each wing is relatively efficient, whilst providing redundancy. This is because the thrust Specific Fuel Consumption (SFC) of gas turbine engines generally decreases with engine size, so it is generally more efficient to have fewer, larger engines. Furthermore, the drag associated with additional engine nacelles is eliminated. Meanwhile, it is a regulatory requirement to provide at least two engines in many cases, such that the aircraft can continue to operate in the event of one engine being inoperative (OEI).

There is also a continuing trend within the aviation industry to provide turbofans and turboprops having a higher bypass ratio, i.e. having a larger proportion of the air mass flow through the fan/propeller disc, rather than through the engine core. In general, larger bypass ratios result in lower SFC. However, as the fan increases in size (i.e. diameter) with high bypass ratio engines, several problems are encountered. These include for example, high fan tip speeds, excessively heavy engines nacelles and fan containment systems (in the case of turbofans), and issues with ground clearance.

One proposal to maintain a subsonic fan tip speed in a large diameter fan is to provide a reduction gearbox between the turbine and fan of the gas turbine engine, such that the fan rotates at a lower speed than the turbine. Such an arrangement is provided for example in the Pratt and Whitney PW1000G™. Such arrangements are also common in turboprops. However, as the fan/propeller diameter is increased further, the rotational speed of the fan must be reduced in order to maintain a subsonic fan/propeller tip speed (which is necessary to avoid the tips becoming supersonic, and so creating large amounts of noise), which in turn results in the gearbox having to handle a large amount of torque for a given power rating, due to the increased reduction ratio. Consequently, the gearbox may be relatively heavy, and it may not be possible to scale such an arrangement up to higher thrusts or bypass ratios.

An alternative solution is to drive a plurality of ducted or unducted fans using a common gas turbine engine core, thereby permitting each fan to have a smaller diameter, while maintaining a high bypass ratio for the propulsion system as a whole. One such example is disclosed in U.S. Pat. No. 8,402,740, in which bevel gears are used to power two non-coaxial fans from a single gas turbine engine core shaft. U.S. Pat. No. 8,015,796 describes an arrangement in which a layshaft gearbox is used to transfer power to the non-coaxial fans. Another alternative solution is to transfer power from one or more gas turbines to a plurality of remotely sited fans or propellers via electrical generators and an electrical transmission network. Such arrangements are described for example in Gohardani, A. S. ‘A synergistic glance at the prospects of distributed propulsion technology and the electric aircraft concept for future unmanned air vehicles and commercial/military aviation’, Progress in Aerospace Sciences, Volume 57, February 2013. However, such arrangements introduce inefficiencies in view of the requirement to convert mechanical power to electrical power, and back again. These disadvantages may be partly overcome using superconducting generators, motors and cables. However, these technologies are relatively immature, and can be expected to add additional weight and cost.

Each of these solutions generally increases the weight of the powerplant, and so may result in a net reduction (or only very slight net increase) in overall aircraft level efficiency, at significantly increased cost. Furthermore, there must be provision made for OEI operation, and so at least two separate powerplants (i.e. gas turbines or reciprocating engines) are required. In the case of an electric distributed propulsion aircraft, provision must be made for the failure of either a gas turbine engine, an electrically driven propulsor, or a generator, leading to potentially extensive redundancy, and so high cost. Even so, where the engines are installed on the wings of the aircraft, a large amount of rudder deflection will be required in the event of the loss of one gas turbine engine in view of the resultant asymmetric thrust. This may restrict the design of the aircraft to particular takeoff and landing speeds (necessitated by the V_{mca}, i.e. the minimum airspeed at which the aircraft is controllable with one engine out), and may also necessitate a relatively large rudder and possibly also relatively large roll control surfaces, which may in turn result in a relatively large amount of drag.

The present invention provides an aircraft propulsion system and an aircraft which seeks to address one or more of the above problems.

According to a first aspect of the invention there is provided an aircraft propulsion system comprising:

at least first and second propulsor arrangements, each propulsor arrangement comprising an internal combustion engine, a plurality of propulsors, a shaft, a reduction gearbox arrangement and a motor generator arrangement, the internal combustion engine being configured to drive the plurality of propulsors via the shaft and the reduction gearbox arrangement, each internal combustion engine being coupled to the motor generator arrangement, the motor generator arrangement being configured to drive at least one of the mechanically driven propulsors when in a motor mode, and to generate electrical power when in a generating mode; and
an electrical interconnector configured to transfer electrical power between the first and second propulsor arrangements.

Advantageously, the arrangement provides an aircraft propulsion system which provides efficient operation, while ensuring that power can be transmitted to at least one of the propulsors of a propulsor arrangement having an inoperative gas turbine engine, due to the motor generator arrangement and the electrical interconnector. Consequently, benefits at an aircraft level can be achieved in view of reduced yaw requirements in the event of the failure of a single gas turbine engine. Furthermore, since a large number of propulsors are provided, the remaining propulsors would only have to provide a moderately increased thrust in the event of a propulsor failure, thereby reducing the nominal rating of each propulsor, and leading to weight and cost advantages.

At least one of the propulsors may comprise one of a ducted fan and an open rotor propeller.

Each of the first and second propulsor arrangements may be mounted to a respective wing.

One or more of the propulsors may be located having an inlet located upstream of a leading edge of an aircraft wing. One or more of the propulsors may be located such that a wing flap is located in a slipstream of the respective propulsor. The invention is thought to be particularly advantageous in such an arrangement, as the slipstream produced by the propellers increases the effectiveness of the flaps. Consequently, the wing can be made smaller, thereby reducing net aircraft drag. However, in such arrangements, a lift imbalance would occur where propulsors on one wing were to be inoperative. In view of the electrical interconnector and motor generators coupled to propulsors, this disadvantage is reduced or eliminated.

The propulsion system may comprise at least one propulsor located so as to ingest a boundary layer airflow in use. The propulsion system may comprise at least one propulsor having an inlet located rearwardly of a trailing edge of the wing. Advantageously, the propulsors ingest a boundary layer airflow in use, thereby reaccelerating boundary airflow, and so improving the propulsive efficiency of the aircraft.

The system may comprise a tip propulsor comprising a propulsor mounted to a wing tip, having an inlet adjacent the wing tip. The tip propulsor may be electrically driven, and may be located having an inlet located downstream of a leading edge of the wing tip, and may be located having an inlet located downstream of a trailing edge of the wing tip. The system may comprise a tip propulsor controller configured to control thrust generated by the tip propulsor in accordance with a yaw demand. Advantageously, the tip propulsor can be used to provide yaw control, thereby reducing the impact of an OEI yaw imbalance, thereby in turn allowing a further reduction in vertical stabiliser/rudder surface area. Thus the disclosed system may have a reduced weight and aerodynamic drag compared to prior systems. In view of the positioning of the tip propulsor inlet adjacent the wing tip, wing tip vortices can be reduced. It has been found that, in many instance, the maximum power required by the gas turbine engines in a high bypass ratio propulsion system is defined by the power required for “second segment” climb, i.e. climb to a high altitude after takeoff. Under such conditions, in which the wings must operate at high lift coefficients, vortices are shed from the wingtip. The vortices represent a significant contributor to drag in second segment climb, and so reducing these vortices can be expected to reduce the power requirement during this phase of flight, and so reduce the power requirement of the gas turbine engines. Consequently, the gas turbine engines can be made lighter in view of the reduced power requirements, resulting in large efficiencies beyond the direct efficiencies produced by reducing drag associated with wing tip vortices.

The system may comprise a boundary layer ingesting electrically driven propulsor mounted at a rearward end of an aircraft fuselage, having an inlet downstream of a trailing edge of the aircraft fuselage.

The one or more shafts may be configured to disconnect in the event of a failure of one of a coupled component. For example, the one or more shafts may comprise a clutch or frangible link. Advantageously, in the event of a failure of one of a coupled component such as a gearbox, a propulsor or a motor generator, the remaining coupled components can continue to operate.

The reduction gearbox arrangement may comprise a bevel gearbox configured to transfer shaft power from a gas turbine engine driving shaft to a first shaft having an axis of rotation generally coaxial to the gas turbine engine driving shaft, and to a second shaft having an axis of rotation generally normal to the gas turbine engine driving shaft.

At least one motor generator may be coupled to the second shaft.

The propulsion system may comprise one or more further bevel gearboxes configured to transfer shaft power from the second shaft to a propulsor driving output shaft having an axis of rotation generally normal to the axis of rotation of the second shaft.

According to a second aspect of the present disclosure there is provided an aircraft comprising a propulsion arrangement in accordance with the first aspect of the disclosure.

The skilled person will appreciate that except where mutually exclusive, a feature described in relation to any one of the above aspects of the invention may be applied mutatis mutandis to any other aspect of the invention.

Embodiments of the invention will now be described by way of example only, with reference to the Figures, in which:

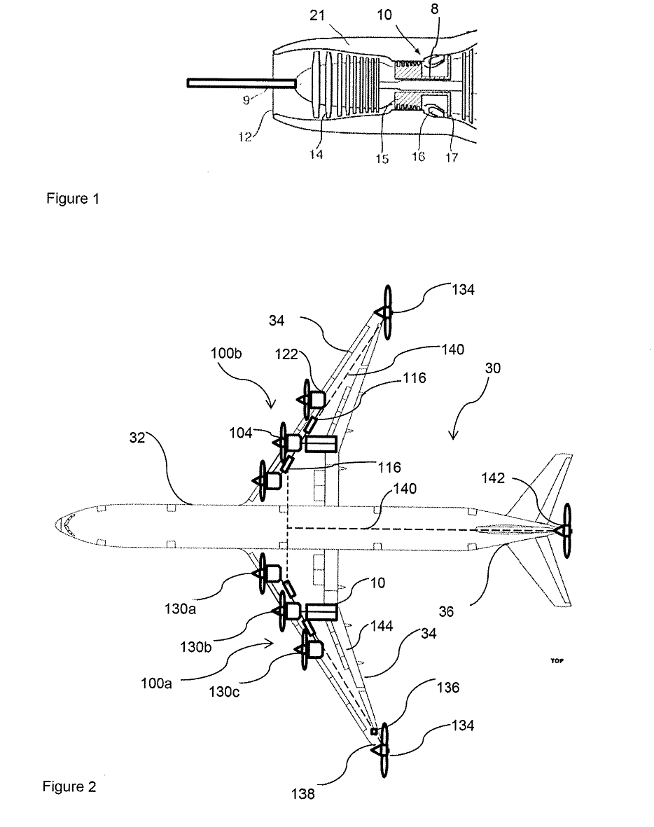

FIG. 1 is a sectional side view of a gas turbine engine;

FIG. 2 is a cross sectional plan view of an aircraft having a propulsion system in accordance with the present disclosure;

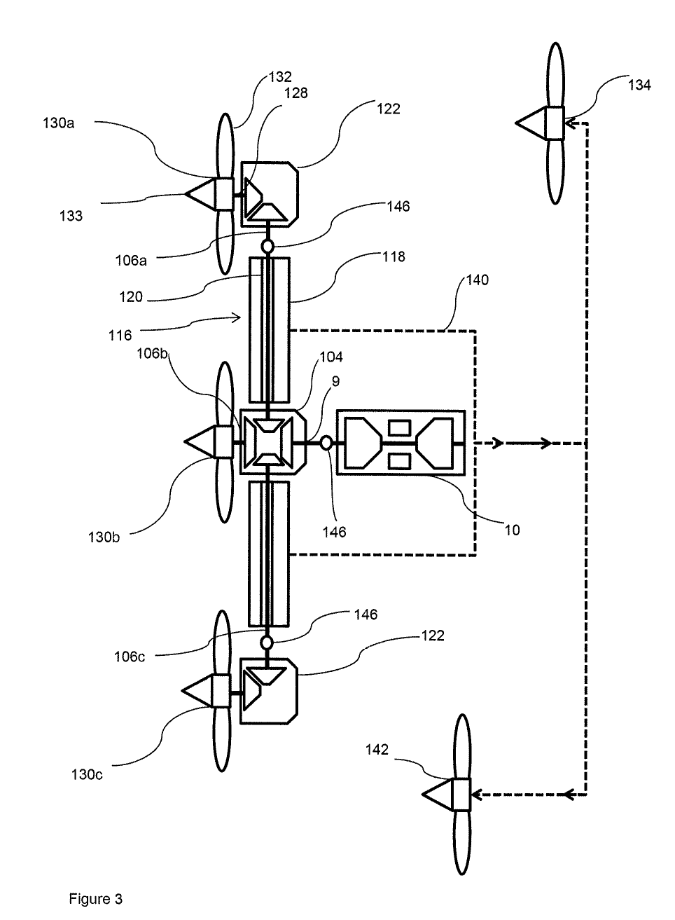

FIG. 3 is a diagrammatic overview of part of the propulsion system of the aircraft of FIG. 2; and

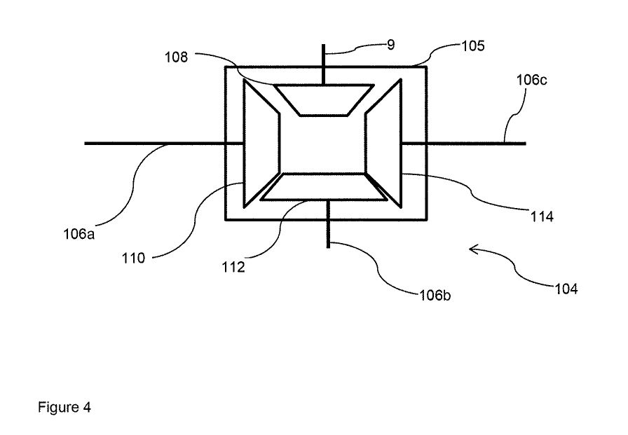

FIG. 4 is a diagrammatic cross sectional view through a gearbox of the system shown in FIG. 3.

Referring to FIG. 1, a twin-spooled, gas turbine engine is generally indicated at 10. The engine 10 comprises a core engine 11 having, in axial flow series, an air intake 12, a low pressure compressor 14, a high-pressure compressor 15, combustion equipment 16, a high-pressure turbine 17, a low-pressure turbine 18 and a core exhaust nozzle 20. A nacelle 21 generally surrounds the core engine 11 and defines the intake 12, nozzle 20 and a core exhaust duct 22. High and low pressure shafts 8, 9 couple the high and low pressure compressors 14, 15 and turbines 17, 18 respectively. The low pressure shaft 24 extends forward of the core engine 11 to drive a load.

The gas turbine engine 10 works in a conventional manner so that air entering the intake 12 is accelerated and compressed by the intermediate pressure compressor 14 and directed into the high-pressure compressor 15 where further compression takes place. The compressed air exhausted from the high-pressure compressor 15 is directed into the combustion equipment 16 where it is mixed with fuel and the mixture combusted. The resultant hot combustion products then expand through, and thereby drive the high pressure and low pressure turbines 17, 18 before being exhausted through the nozzle 20 to provide some propulsive thrust.

The gas turbine engine 10 is part of a propulsion system 100 of an aircraft 30, shown in more detail in FIG. 2.

Referring to FIG. 2, the aircraft 30 comprises a fuselage 32 which defines a longitudinal axis, and provides internal space for passengers and cargo. Attached to the fuselage is a pair of wings 34 and an empennage 36 comprising vertical and horizontal surfaces.

The propulsion system comprises a pair of propulsor arrangements 100a, 100b, each of which is mounted to a respective wing 34. One of the propulsor arrangements is shown schematically in more detail in FIG. 3.

Each propulsor arrangement 100a, 100b comprises a two spool gas turbine engine 10 mounted to a respective wing 34 within a nacelle 21, and a plurality of mechanically driven propulsors 130a-c. The low pressure shaft 9 of the gas turbine engine 10 drives a reduction gearbox 104, shown in further detail in FIG. 4.

Referring to FIG. 4, the reduction gearbox 104 is contained within a housing 105. The low pressure shaft 9 is the input shaft for the reduction gearbox 104, and drives an input bevel gear 108. The input bevel gear 108 is configured to transfer power to three output shafts 106a, 106b, 106c via respective intermediate bevel gears 110, 112 and final bevel gear 114 respectively. The axes of rotation of gears 108, 110, 112, 114 and shafts 9, 106a-c are arranged generally orthogonally, such that the input bevel gear 108 drives intermediate bevel gears 110, 114, and intermediate bevel gears 110, 114 in turn drive final bevel gear 112. Gears 108, 110, 114 have diameters and teeth numbers such that a reduction ratio of approximately 4:1 or higher is provided between the input shaft 9 and output shafts 106a, 106b, 106c. It will be understood though that different reduction gear ratios could be employed. In order to provide such a reduction on all three output shafts 106a-c while maintaining a 90° angle between the input shaft 9 and output shafts 106a, 106c, gear 112 and shaft 106b could be offset to the other gears 108, 110, 114 in a direction normal to their rotational axes, for example in a vertical direction (i.e. into or out of the page in the diagram shown in FIG. 4).

Alternatively, the gearbox could provide a different reduction ratio for different output shafts. For example, the gears 108, 110, 114 could have the same number of teeth, with gear 112 having a greater number of teeth, such that the output shafts 106a, 106c rotate at the same speed as the input shaft 9, with output shaft 106b rotating at a lower rotational rate than the input shaft 9. Advantageously, such an arrangement can provide relatively high reduction ratios of 4 or greater, since an epicyclic gearbox is not required. Consequently, the gas turbine engine spools can rotate at relatively high speeds (which results in high turbine tip speeds without requiring large diameter turbine discs), while the propulsors 130a-c can operate at low speeds (which results in efficient propulsion in view of the low tip speeds). In contrast, the reduction ratio of epicyclic gearbox is generally limited to around 4:1. High reduction gear ratios will also reduce the torque requirements of the shafts and driven equipment.

Shafts 106a and 106b extend in generally opposite directions to one another, and have axes of rotation generally normally to the input shaft 9, and extent in a generally spanwise direction. Consequently, the gearbox 104 splits power from the low pressure input shaft 9 into two outputs having a different axis of rotation to the input shaft 9, and a lower rotational speed. Meanwhile, the output shaft 106b is arranged to rotate generally coaxially with the input shaft 24.

Each propulsor arrangement 100 further comprises a pair of motor generators 116. The motor generators 116 comprise a stator 118 having one or more magnetic poles arranged around a rotor 120. The rotor 120 is coupled to a respective shaft 106a, 106c, such that the rotor 120 and shaft 106a, 160c co-rotate. Consequently, where the motor generators 116 are in a generating mode (i.e. where the respective motor generator 116 is being driven by the gas turbine engine 10 via respective shaft 106a, 106b), rotation of the shaft 106a generates electrical power, whereas where the motor generator is in a motor mode (i.e. being provided with electrical power), the electrical power provided to the stator 118 causes the motor to drive the respective shaft 106a, 106b. The respective shaft 106a, 106c, rotor 120 and stator 118 are arranged concentrically, and generally have a high aspect ratio, such that the motor generators 116 extend for a substantial portion of the overall length of the shaft 106a, 106c. Consequently, the motor 116 is relatively compact, having a relatively small diameter. As such, the motor 116 can generally be located within the wing 34. In general, the motor/generator is located close to the leading edge of the wing, where the wing is thickest. Each motor generator 116 comprises an AC motor generator, such as a synchronous or asynchronous motor.

The shafts 106a, 106c are coupled to a further respective bevel gearbox 122 at a distal end thereof, and thereby provide an input shaft of the respective bevel gearbox 122. The bevel gearboxes 122 comprise a pair of bevel gears 124, 126 arranged generally orthogonally, such that an output shaft 128 of the bevel gearbox has an axis of rotation generally normal to the axis of rotation of the input shaft 106a, 106c. In the described embodiment, the bevel gearbox translates the axis of rotation, but does not provide a reduction gear. Such an arrangement, in conjunction with the gearbox 104, ensures that the propellers 130a, 130c rotate in opposite directions to propeller 130b. Such an arrangement reduces the P-factor, and reduces aerodynamic interference between the propellers, thereby increasing propulsive efficiency.

The output shaft 128 of each bevel gearbox 122 is coupled to a propulsor in the form of an open rotor propeller 130a, 130c. Each propeller 130a, 130c has at least one propeller blade 132 attached by a hub 133, and is configured to provide thrust when rotated. Similarly, shaft 106b directly drives a further propeller 130b. Consequently, the gas turbine engine 10 drives the propellers 130a, 130b, 130c via the reduction gearbox 104, and also via bevel gearbox 122 in the case of propellers 130a, 130c. In view of the relatively large number of propellers (i.e. three in the described embodiment), the propulsion system 100 can have a large effective bypass ratio whilst having relatively small diameter propellers 130a-c. Consequently, the propellers can rotate at relatively high speed without encountering supersonic tip speeds. As a result, the reduction ratio provided by the reduction gearbox arrangement can be relatively low, such that the engine shaft 24 can run at a relatively high speed (which results in a relatively efficient turbine), while the output shafts run at only a slightly lower speed. As a consequence, relatively small, low weight gearboxes can be provided.

Each propulsor arrangement further comprises at least one shaft disconnection arrangement in the form of a plurality of frangible connections 146. Each frangible connection is configured to uncouple a respective shaft 106a, 106c from the remaining shafts and gearboxes in the event of a failure of one of the gearboxes, shafts or mechanically driven propulsors 130a-c. For instance, the frangible connections 146 may be configured to physically break where a maximum load is exceeded. Consequently, failure of one mechanically driven component will not propagate to other components, thereby providing additional redundancy.

The propulsor arrangements 100 are electrically interconnected by an interconnector 140. The interconnector 140 is an electrical connector which electrically couples the motor generators 116 of the left propulsor arrangement 100a, with the motor generators 116 of the right propulsor arrangement 100b. Consequently, in the event of a failure of the gas turbine engine 10 of one of the propulsor arrangements, power can be transferred from one propulsor arrangement 100a, 100b to the other electrically. For example, where the left propulsor arrangement 100a gas turbine engine 10 fails in flight, the motor generators 116 of the right propulsor arrangement 100b would be operated in a generator mode, while the motor generators 116 of the left propulsor arrangement 100a would be operated in a motor mode. Consequently, the propulsors 130a-c of the left propulsor arrangement 100a would continue to operate in OEI conditions, when one gas turbine engine 10 has failed. In such circumstances, a load on the shafts 106 of the right propulsor arrangement 100b would be produced by the motor generators 116 operating in generator mode. Consequently, it may be desirable for the propulsors 103 to comprise variable pitch rotors 132, such that the aerodynamic load on the propulsors 130 can be modified in order to accommodate the increased shaft load. In other words, the pitch may need to be reduced in the event of OEI operation, so that the propulsors can continue to operate at high rotational speed. In some cases, the power transferred between propulsor arrangements 100a, 100b under OEI conditions may be less than 50%—i.e. the propulsor arrangement 100a, 100b having the operative gas turbine engine 10 may provide a greater proportion of the power than the arrangement 100a, 100b having the inoperative gas turbine engine 10. Since the interconnector may experience some resistive losses (estimated at perhaps 5% of transmitted power), the propulsive efficiency of the system as a whole can be increased by transmitting less than 50% of the power through the interconnector 140. The resultant thrust imbalance can be accommodated by utilising tip propulsors 134, or using the rudder.

Referring once more to FIG. 3, the mechanically driven propulsors 130a, 130c of each propulsion system 100a, 100b are located upstream of trailing edge flaps 144 of each wing 34. Consequently, the flaps 144 are located in the slipstream of the propulsors 130a-c. Such an arrangement is known in the art as “externally blown flaps” or “powered lift”. As a result, the wings 34 can be operated at a greater coefficient of lift compared to where only a single, relatively small diameter propulsor is used. Consequently, the wing area can be made smaller, while still providing sufficient lift for takeoff at acceptably low speeds. As a result, total airframe drag is reduced. Alternatively, steeper descents can be made. Meanwhile, the redundancy provided by the interconnector 140 and motor generators 116 ensures that the propulsors 130a-c of both propulsor arrangements 100a, 100b continue to operate with one gas turbine engine 10 inoperative, thereby preventing the situation where lift is lost on one wing due to one of the propulsors no longer providing thrust. On the other hand, the gas turbine engine inlets 12 are also located within the slipstream of the propulsor 130b, though this need not be the case.

The propulsion system 100 optionally further comprises at least one tip propulsor 134 mounted to a tip 138 of each wing 34, having the propeller blades 132 located aft of a trailing edge of each wing 34. Each propulsor 134 is driven by an electric motor 138, which is provided with electrical power from the motor generators 116 via the electrical interconnector 140. Consequently, the tip propulsors 134 are located at a point where a wingtip vortex would normally be generated. By rotating the propellers in a clockwise direction as viewed from downstream of the propulsor 134 on the port wing 34, and in an opposite direction on the starboard wing, the wingtip vortex can be at least partly cancelled, thereby reducing the wake vortex. This arrangement would be expected to reduce losses due to tip vortices, and also allow closer spacing between aircraft in congested airspace.

As a further advantage, each tip propulsor 134 is located a large distance from the centre of mass of the aircraft 30, and so the thrust generated by each propulsor 134 may provide a significant yawing moment. By controlling each propulsor 134 via a controller 136 in accordance with a yaw requirement (as determined either manually by the pilot, or in accordance with an OEI schedule), the size of the rudder can be reduced, thereby further reducing drag and weight. In some cases, the rudder, and possibly the vertical tail surface, can be eliminated entirely. On the other hand, since the propulsors 134 are driven by an electric motor provided with electrical power from the propulsor arrangement (rather than a mechanical shaft), the power can be transmitted through the wing without limiting the flexibility of the wing (which would require increasing the stiffness, and therefore the weight of the wing 34), or by requiring flexible couplings, which have increased complexity. In view of the relatively low power requirements of the tip propulsors 134, the electrical interconnector 140 can be relatively light. Since the tip propulsors 134 are powered by electrical power provided by the interconnector 140, electrical power can continue to be provided during OEI operation. Consequently, these propulsors will be particularly advantageous in cancelling any adverse yaw in the event of OEI operation.

A further electrically driven propulsor is provided in the form of a boundary layer ingesting propulsor 142 mounted with the propeller blades 132 being located within the boundary layer at the aft end of the fuselage 32, downstream of the empennage 36. Again, electrical power is provided to the propulsor 142 from the gas turbine engines 10 via the interconnector 140. The boundary layer ingesting propulsor 142 ingests the boundary layer generated by the fuselage 32, thereby increasing the propulsive efficiency of the propulsion system 100. Again, in view of the relatively low power requirements of the propulsor 142, a relatively low weight electrical interconnector 144 can be utilised. Furthermore, in view of the presence of the electrical interconnection 140 between the first and second propulsion arrangements 100a, 100b, at least part of the weight of the electrical interconnector is already accounted for in the design. Consequently, the additional weight of electrical cabling to provide a boundary layer ingesting propulsor at an aft end of the aircraft in addition to the interconnection between the gas turbine engines 10 is relatively small.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

For example, the disclosed propulsion system may be suitable for different types of aircraft, such as blended wing aircraft, in which the fuselage provides lift, such that there is no distinctive separation between the fuselage and wings. Alternatively, the aircraft could have a canard configuration, in which the horizontal tail surfaces are omitted, and replaced by a canard located at a forward end of the fuselage.

The propulsors could be of different types, such as for example ducted fans. The propulsors could be located on different parts of the aircraft. For example, the mechanically driven propulsors could be located at a trailing edge of the aircraft. Such an arrangement would ensure that airflow over the wings is undisturbed by propeller wash, while also ingesting an amount of boundary layer air, thereby increasing the propulsive efficiency of the propulsors. However, such an arrangement may not be compatible with trailing edge flaps, which may necessitate higher landing speeds. Either or both of the tip propulsors or the rear fuselage mounted boundary layer ingesting propulsors could be omitted. Alternatively, further mechanically and/or electrically driven propulsors could be provided.

Other types of motor generator arrangements could be provided. For example, the motor generator arrangement could comprise separate motor and electrical generator units coupled to the same shaft. Different numbers of motor generators could be provided. For example, a single motor generator could be provided for each propulsor arrangement, and could for example be mounted directly to a shaft of the respective gas turbine engine, i.e. not through a reduction gearbox.

Other gearbox arrangements could be provided. For example, power could be mechanically transmitted from the gas turbine engine to the propulsors via a layshaft or planetary gearbox. Instead of a single reduction gearbox, multiple reduction gearboxes could be provided, such that, for instance, the bevel gearbox 104 could have a reduction ratio for only the coaxial output shaft, while rpm reduction could be provided by bevel gearboxes 122. Alternatively, the gearboxes 104, 122 could provide no ratio reduction, with ratio reduction being provided by separate gearboxes provided for each propulsor. The system may also include a step-up gearbox, to increase the rotational speed of shafts carrying the motor/generators, to increase the efficiency and/or reduce the size of the motor gearboxes, with the bevel gearboxes providing a reduction gearbox to reduce the rotational speed of the propellers. Similarly, the motor/generators could be located on a different shaft, such as the output shaft of the bevel gearbox, which may result in more efficient/more aerodynamic packaging of the motor/generator.

The electrical interconnectors could comprise superconducting cables. The motor generators could comprise superconducting electrical machines.

Though the gas turbine engines are shown as having intake located in the slipstream of the propulsors, the gas turbine engines could be arranged to ingest freestream air.

1. An aircraft propulsion system comprising:
at least first and second propulsor arrangements, each propulsor arrangement comprising an internal combustion engine, a plurality of propulsors, a shaft, a reduction gearbox arrangement and a motor generator arrangement, the internal combustion engine being configured to drive the plurality of propulsors via the shaft and the reduction gearbox arrangement, each internal combustion engine being coupled to the motor generator arrangement, the motor generator arrangement being configured to drive at least one of the mechanically driven propulsors when in a motor mode, and to generate electrical power when in a generating mode; and
an electrical interconnector configured to transfer electrical power between the first and second propulsor arrangements.

2. A system according to claim 1 wherein each of the first and second propulsor arrangements is mounted to a respective wing.

3. A system according to claim 1, wherein one or more of the propulsors is located such that a wing flap is located in a slipstream of the respective propulsor.

4. A system according to claim 1, wherein the propulsion system comprises at least one propulsor located so as to ingest a boundary layer airflow in use.

5. A system according to claim 4, wherein the system comprises a boundary layer ingesting electrically driven propulsor mounted at a rearward end of an aircraft fuselage, having an inlet downstream of a trailing edge of the aircraft fuselage.

6. A system according to claim 2, wherein the system comprises a tip propulsor comprising a propulsor mounted to a wing tip, having an inlet adjacent the wing tip.

7. A system according to claim 6, wherein the system comprises a tip propulsor controller configured to control thrust generated by the tip propulsor in accordance with a yaw demand.

8. A system according to claim 1, wherein the one or more shafts are configured to disconnect in the event of a failure of one of a coupled component.

9. A system according to claim 1, wherein at least one of the propulsors comprises one of a ducted fan and an unducted propeller.

10. A system according to claim 1, wherein the reduction gearbox arrangement comprises a bevel gearbox configured to transfer shaft power from a gas turbine engine driving shaft to a first shaft having an axis of rotation generally coaxial to the gas turbine engine driving shaft, and to a second shaft having an axis of rotation generally normal to the gas turbine engine driving shaft.

11. A system according to claim 9, wherein at least one motor generator is coupled to the second shaft.

12. A system according to claim 9, wherein the propulsion system comprises one or more further bevel gearboxes configured to transfer shaft power from the second shaft to a propulsor driving output shaft having an axis of rotation generally normal to the axis of rotation of the second shaft.

13. An aircraft comprising a propulsion arrangement in accordance with claim 1.
